(19) United States
(12) Patent Application Publication
(10) Pub. No.: US 2018/0010710 A1
(43) Pub. Date: Jan. 11, 2018

(54) METHOD AND APPARATUS FOR BIASING FAUCET HANDLE

(71) Applicant: David Stephen Straka, Rahway, NJ (US)

(72) Inventor: David Stephen Straka, Rahway, NJ (US)

(21) Appl. No.: 15/203,518

(22) Filed: Jul. 6, 2016

(51) Int. Cl. F16K 31/60; F16K 11/02

(52) U.S. Cl. CPC F16K 31/605; F16K 11/02

(57) ABSTRACT

An apparatus including a handle device; a valve device for controlling water flow, the valve device having a first opening; and a device for biasing the handle device such that changing the handle device from an off state to an on state, without intentionally moving the handle device towards a hot water position or a cold water position, causes the handle device to cause the valve device to direct either hot or cold water, but not both, from either a hot supply pipe or a cold supply pipe, respectively, and out of an opening from the valve device. The device for biasing the handle device may include a spring.

### FIELD OF THE INVENTION

This invention relates to improved methods and apparatus concerning single lever faucets.

### BACKGROUND OF THE INVENTION

There are various devices known as faucets, such as water faucets. For example, there are mainly two classifications of sink faucets design in use today. They are (a) Dual valve: Hot on left and Cold on right. Spout in the middle. (b) Single Lever type. Hot and cold mixing integrated into one lever and valve control. These two types make up 99% of all faucets. Other types of existing faucets include foot control or motion detection types seen in public facilities.

There are “Energy Saving Faucets” but typically these function by saving on the amount of water that flow per minute and standards are set by gallons per minute.

### SUMMARY OF THE INVENTION

One or more embodiments of the present invention save on energy or on hot water by controlling the amount or ratio of hot versus cold water being drawn from the a single lever faucet.

In one or more embodiments of the present invention, a faucet, such as a single lever mechanical faucet is mechanically positioned such that its lever is biased at rest in the cold “OFF” direction, such as by a torsional spring. Then when the faucet is activated next time “ON”, it is more likely to be done in a “COLD” only direction saving any hot water from being drawn from the hot water tank for just moments at a time when typically hands are being washed or teeth are being brushed. Today users push the single lever faucet “ON” with no regard to its position and are unaware of the effect it has on drawing hot water from the tank for short periods of time.

Most short term uses of a sink and faucet do not require hot water and/or the users are not willing to wait for hot water to arrive at the spout to complete their task. Therefore at every single lever faucet globally, small amounts of hot water are being drawn from the hot water tank and never being realized for use. Therefore the energy spent to heat that water is wasted. The energy savings of this invention is astronomical and could be government mandated in a short period of time.

The inventor has surveyed single lever faucets in homes over many years, and most of them are left in the middle/center positions or slightly off center. This position will draw 50% hot and 50% cold when turned on. From the inventor's past three homes experiences, he typically needed to run the water for minutes or several gallons until the spout temperature gets warm. Again, most sink tasks require short intervals of water use before the spout temperature ever has the time to get warm.

The typical place to apply this invention would be wash sinks in bathrooms, powder rooms, laundry room sinks and kitchen sinks. These locations are unlike a shower or tub installation where when in use, the occupant would most likely want to wait for hot water to arrive for bathing needs.

In at least one embodiment of the present invention, an apparatus is provided including a handle device; a valve device for controlling water flow, the valve device having a first opening; and a device for biasing the handle device such that changing the handle device from an off state to an on state, without intentionally moving the handle device towards a hot water position or a cold water position, causes the handle device to cause the valve device to direct either hot or cold water, but not both, from either a hot supply pipe or a cold supply pipe, respectively, and out of an opening from the valve device.

The device for biasing the handle device may include a spring. The handle device may be configured with respect to the valve device, such that the handle device can rotate in a first plane, clockwise and counterclockwise, wherein rotating the handle device as far as it will go clockwise in the first plane, puts the handle device in a hot or cold water position, and rotating the handle device as far as it will go counterclockwise in the first plane, puts the handle device in a cold or hot water position, opposite that of the clockwise rotation.

The handle device may be configured with respect to the valve device, such that the handle device can rotate in a second plane, substantially perpendicular to the first plane, clockwise and counterclockwise, wherein rotating the handle device as far as it will go clockwise in the second plane, puts the handle device in an off or on state, and rotating the handle device as far as it will go counterclockwise in the second plane, puts the handle device in an on or off state, opposite that of the clockwise rotation; wherein when the handle device is in a cold water position, and an on state, the handle device causes the valve device to direct cold water from a cold supply pipe out of the opening from the valve device; and wherein when the handle device is in a hot water position, and an on state, the handle device causes the valve device to direct hot water from a hot supply pipe out of the opening from the valve device.

The handle device may be a single lever handle device. The apparatus may further include a spout device, having a first opening and a second opening opposite the first opening; and wherein the valve device directs water out of its opening into the first opening of the spout device, and then the water is directed by the spout device through the second opening of the spout device.

The spring may have a first end which is connected to the handle device and a second end opposite the first end of the spring, wherein the second end of the spring is fixed to a member which remains stationary while the handle device rotates, such that the spring is configured to apply torque on the handle device, when the handle device is rotated.

One or more embodiments of the present invention may include a method comprising the steps of using a device to bias a handle device of a faucet, such that changing the handle device from an off state to an on state, without intentionally moving the handle device towards a hot water position or a cold water position, causes the handle device to cause a valve device to direct either hot or cold water, but not both, from either a hot supply pipe or a cold supply pipe, respectively, and out of an opening from the valve device.

### BRIEF DESCRIPTION OF THE DRAWINGS

FIG. 1 shows a perspective view of a faucet apparatus in accordance with an embodiment of the present invention, with the faucet apparatus in a first partially assembled state;

FIG. 2 shows a perspective view of some of the components of the faucet apparatus of FIG. 1, in a second partially assembled state;

FIG. 3 shows a perspective view of the faucet apparatus of FIG. 1, with the faucet apparatus of FIG. 1 in a third partially assembled state;

FIG. 4 shows a perspective view of the faucet apparatus of FIG. 1, with the faucet apparatus of FIG. 1 in a fourth partially assembled state;

FIG. 5 shows a perspective view of the faucet apparatus of FIG. 1, with the faucet apparatus of FIG. 1 in a fifth partially assembled state; and

FIG. 6 shows a perspective view of the faucet apparatus of FIG. 1, with the faucet apparatus of FIG. 1 in an assembled state.

### DETAILED DESCRIPTION OF THE DRAWINGS

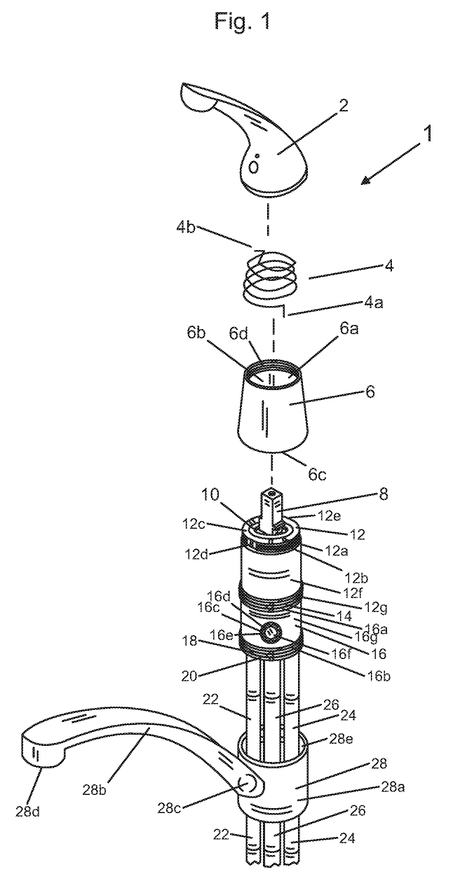

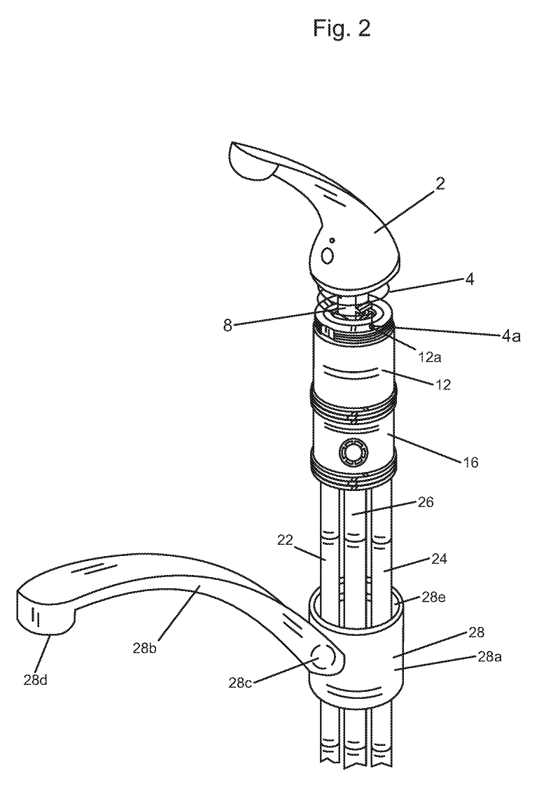

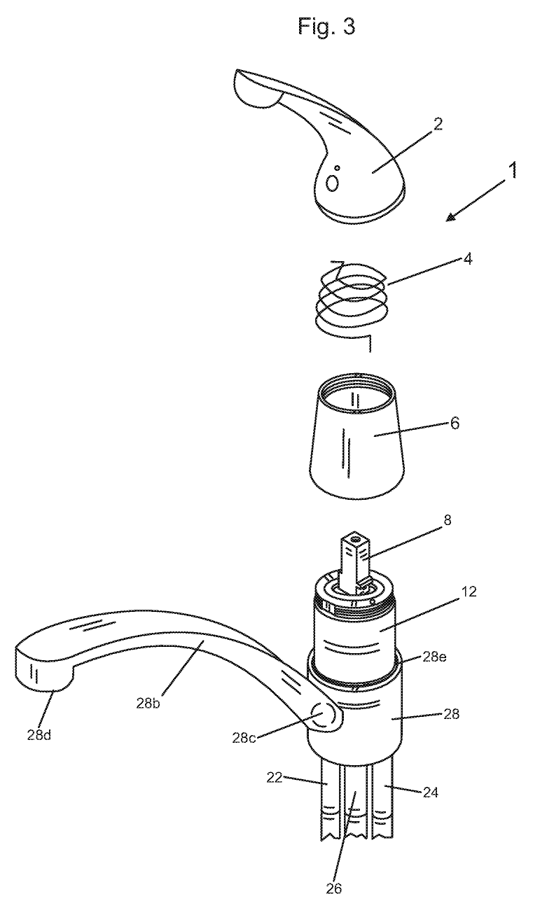

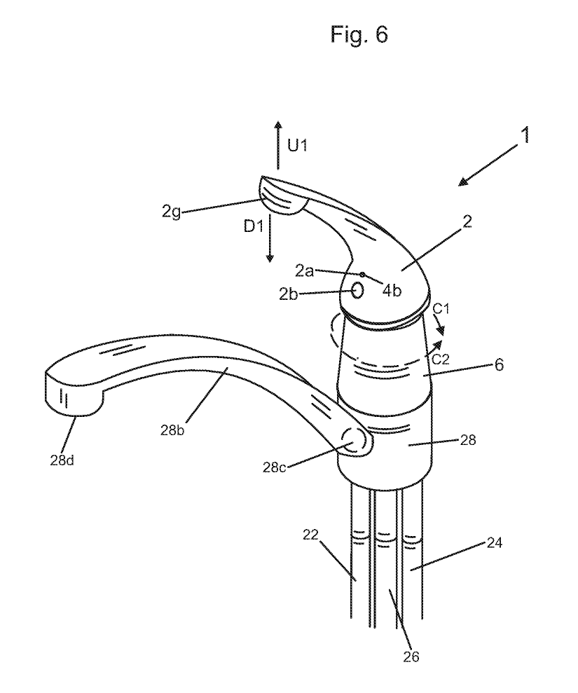

FIGS. 1, 3, 4, and 5 show perspective views of a faucet apparatus 1 in accordance with an embodiment of the present invention, with the faucet apparatus 1 in first, third, fourth, and fifth partially assembled states, respectively. FIG. 2 shows a perspective view of some of the components of the faucet apparatus 1, in a second partially assembled state. FIG. 6 shows a perspective view of the faucet apparatus of FIG. 1, with the faucet apparatus of FIG. 1 in an assembled state.

Referring to FIGS. 1, 3, 4, and 5, the faucet apparatus 1 includes a handle device 2, a spring 4, a frustrum or cone section 6, a valve stem 8, a valve assembly 10, a valve retainer ring 12, washer 14, a cylinder device 16, a washer 18, a flange, fringe or peripheral protrusion 20, a hot water pipe 22, a cold water pipe 24, a an outlet feed for hand held auxiliary spout application 26, and a spout device 28.

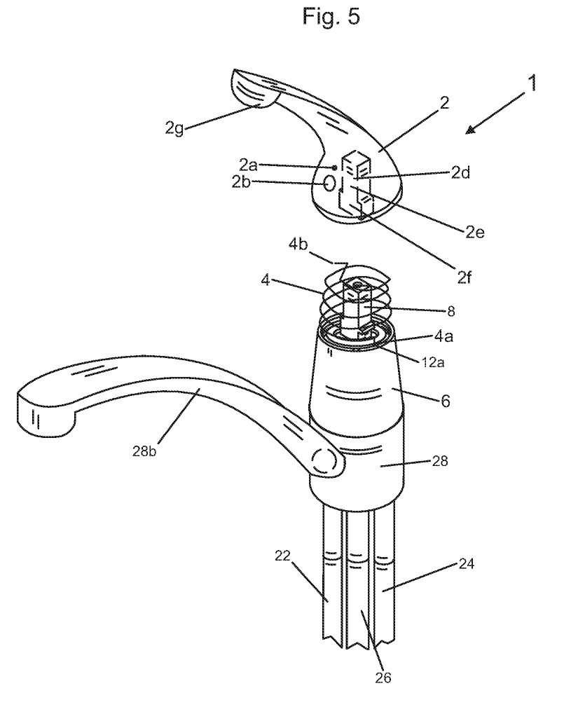

The handle device 2 includes a hole or openings 2a, and a handle set screw access opening 2b usually kept covered by a plug. The handle device 2 includes an inner cavity 2d which may have a rectangular prism inner chamber section 2d and a rectangular prism inner chamber 2f, as shown by dashed lines in FIG. 5. The handle device 2 includes an end 2g, by which an individual can grip the handle device 2, and deflect the handle device 2 in the up direction U1, the down direction D1, or in the clockwise direction C1 or the counter clockwise direction C2, when the apparatus 1 is fully assembled as shown in FIG. 6. The movement in the U1 and D1 directions is in a first plane, and the movement in the C1 and C2 directions is in a second plane which is perpendicular or substantially perpendicular to the first plane. The movement in the up direction, U1, can also be described as a clockwise movement in the first plane which is substantially perpendicular to the second plane. The movement in the down direction, D1, can also be described as a counterclockwise movement in the first plane. When the apparatus 1 is fully assembled, as in FIG. 6, an individual can deflect and/or rotate the handle end 2g up in the direction U1 to cause water to flow out of the end 28d of the spout device 28, and down in the direction D1 to cause water to stop flowing out of the end 28d of the spout device 28. The individual can also deflect and/or rotate the handle end 2g, as far as possible in the clockwise direction C1 to cause, for example, hot water to flow out of the end 28d of the spout device 28, and in the counterclockwise direction C2 to cause, for example, cold water to flow out of the end 28d of the spout device 28.

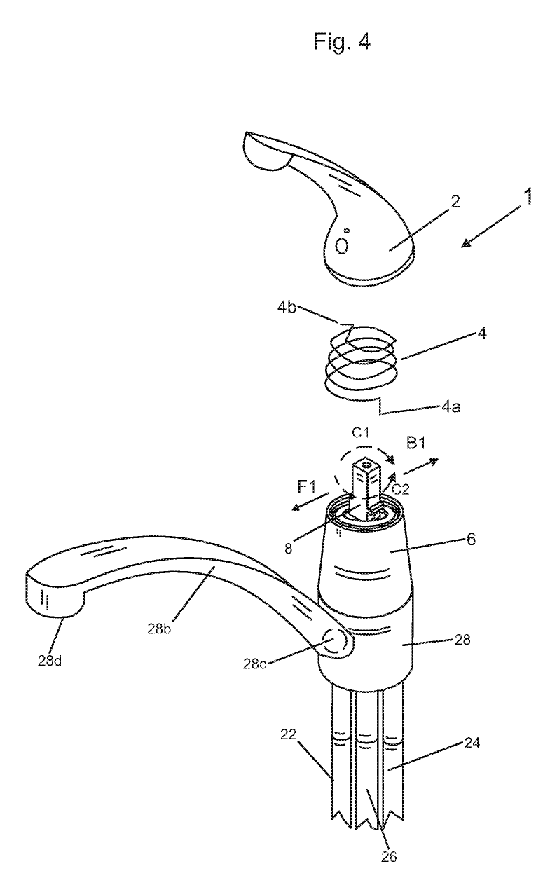

The handle device 2 may be any type of handle device for a faucet, such as a water faucet, or a kitchen water faucet, as known in the art, with the exception of the hole 2a shown in FIGS. 5 and 6. The hole 2a is sized and configured to accept and retain an end 4b shown in FIG. 4 of the spring 4, when the apparatus 1 is in the assembled state shown in FIG. 6. The other end 4a of the spring 4, is configured and sized to be inserted into and retained by an opening or hole 12a in the retainer ring 12, as shown by FIG. 2. In this manner the handle device 2 is biased in a certain default orientation, in one example, towards as far as possible in the counter clockwise direction C1, as opposed to centered, so that cold water will come out of the end 28d of the spout device 28, when the handle end 2g is deflected up in the direction U1, while the orientation plaint of the C1 and C2 directions, remains in the default orientation. This biases the apparatus 1, into providing cold water by default, and saves energy required to produce hot water.

The spring 4 may be any known spring, such as a spring made of an engineered non rusting metal with a high memory attribute so after many torque cycles the spring will return the lever to the cold water side throughout the life expectancy of the faucet assembly. Stainless Steels of different standard chemistries will meet these requirements.

The frustum or cone 6 may be any known type, and typically will be made of metal. The frustum or cone 6 typically has an opening 6a, leading to an inner chamber 6b, leading to an opening 6c, as identified in FIG. 1. The frustum or cone 6 is typically used for aesthetic purposes to provide a clean, polished finished look for the assembled apparatus shown in FIG. 6, and to provide protection of inner components from damage. The frustum 6 includes inner threads 6d which can be screwed onto outer threads 12b of cylinder 12 to attach the frustum or cone 6 to the cylinder 12 to thereby aesthetically cover and protect the cylinder 12 another other inner components of the apparatus 1.

When the device 8 is located inside of the inner chamber 2d of the handle device 2, shown in FIG. 5, and the handle device 2 is attached in the position shown in FIG. 6, then deflecting the handle end 2g upwards in the direction U1, causes the device 8 to go backwards in the direction B1, shown in FIG. 4, and this causes water flow through the spout device 28 and out opening 28d. Deflecting the handle end 2g down in the direction D1, causes the device 8 to go forwards in the direction F1, shown in FIG. 4, and this causes water to stop flowing through the spout device 28 and out opening 28d. In addition, turning the handle device 2 in the clockwise direction C1 shown in FIG. 6, turns the device 8 shown in FIG. 4, in the clockwise direction C1, which causes hot water to come out of the opening 28d of the spout device 28 when the handle end 2g has been pushed in the up direction U1 as far as it will go. Similarly, turning the handle device 2 in the counterclockwise direction C2 shown in FIG. 6, turns the device 8 shown in FIG. 4, in the counterclockwise direction C2, which causes cold water to come out of the opening 28d of the spout device 28 when the handle end 2g has been pushed up in the up direction U1 as far as it will go.

The combination of device 8, device 10, cylinder 12, washer 14, and cylinder 16 is a valve device which controls water flow, and which takes water from either hot water supply pipe 22 or cold water supply pipe 24, and causes the selected water (hot or cold) to come out of a plurality of spaces 16e located in cylinder 16, and then be supplied to spout opening 28c, when a central valve piece 16f of cylinder 16 is aligned with the spout opening 28c. Water coming into the spout opening 28c from the spaces 16e, when 16f is aligned with opening 28c, passes into an internal chamber within spout body 28b, and then out the spout opening 28d.

The device 8 sits in the device 10 and can be moved in the directions F1 and B1, and rotated in the directions C1 and C2, with respect to the device 10 and with respect to the cylinder 12. The device 10 is fixed within the cylinder 12. The cylinder 12 may be metal or plastic. The cylinder 12 includes a top surface 12c which has a hole 12a into which the spring end 4a is configured to be inserted. The cylinder 12 includes flat faces 12d and 12e, are situated opposite one another so that a wrench can be used to take the cylinder 12 apart from the cylinder 16. The cylinder 12 includes a body portion 12f, and a flange or rim 12g.

The washer 14 may have an outer diameter which is slightly larger than the outer diameter of the rim 12g to prevent leaks from occurring.

The cylinder 16 may include a rim or flange 16a, a body portion 16g, a rim 16b, a disk 16c, and a plurality of spokes 16d and spaces 16e. The cylinder 16 includes a central member 16b.

The devices 8 and 10, cylinders 12, and 16 may be known devices with the exception of the configuration of hole 12a configured for acceptance end 4a of the spring 4.

In operation, after the apparatus 1 is assembled as in FIG. 6, the handle device 2 is automatically, by default, biased (as a result of spring 4) in the cold direction, which may be as far counterclockwise C2, as the handle device 2 can turn, so that if the handle end 2g is deflected upwards as far as possible in the direction U1 (while the handle device is biased as far as possible in direction C2), cold water will be directed from cold water pipe 24 to and through spaces 16e of cylinder 16, to the opening 28c of spout device 28, through the inner chamber of spout body portion 28b and out opening 28d. In this manner, someone initially getting water from spout end 28d, will get cold water to save hot water, and thus save energy.

If an individual wants hot water, they would need to turn the handle device in the direction C1 (clockwise) as far as it will turn in that direction, hold it in that orientation in the C1-C2 plane (which is parallel to surface 12c of cylinder 12), and then deflect the handle end 2g, upwards as far as it will deflect in the direction U1.

When the individual releases the handle device 2, the handle device will automatically by default (as a result of biasing spring or device 4) to back to a cold position, in the C2 counterclockwise direction (in this example), as far in the C2 direction as possible.

The present invention, in one or more embodiments, uses the general technique and mechanism of putting a cold direction torque on the lever mechanism, such as by used of spring 4, when the lever, such as end or lever 2g of handle device 2 is pulled down or generally toward the OFF position. When the lever or end 2g, is pushed ON or upwards in the direction U1, that cold off torque, such as exerted by the spring 4, on the handle device 2, would be overcome from using flowing water pressure or another mechanical means thereby allowing the user to select hot or a hot ratio if desired and willing to wait for the correct temperature to arrive. Once the user selects some amount of hot or all hot, the lever with valve friction added by water pressure applied to the valve assembly will create a higher force needed to shift it to the cold water side. In this manor, the user does not need to keep their hand on the lever while waiting for hot water to arrive. I can experiment with forces needed in the on and off positions showing there is a significant difference greater force needed for temperature selection when water is flowing. Let discuss this topic.

There are one hundred and twenty four million residences in the United States of America. There is an average of three faucets per residence. I believe each home will save ten gallons of hot water per day on the average. A gallon costs five cents to heat. That is fifty cents per day or $182 per year. This modification or cost premium will easily justify the cost.

One or more embodiments of the present invention are most beneficial for sink locations. One or more embodiments of the present application may not be useful at tub or shower locations because the user is almost always interested in turning hot water “ON” so they can bathe or shower in warm water. This fact implies the cold side return default would not preserve energy in incidental short period uses at tubs and showers as sinks do.

There are many variations of the single lever faucet utilizing a stem which rotates clockwise or counterclockwise to adjust the amounts of cold and hot water mix into the spout. A common torque spring 4 as shown above could be used sized for the exact faucet with existing parts modified to accommodate the spring 4 with anchor points such that when it is assembled a pre-loaded torque is placed on the stem or ball valve, such as stem or device 8 in FIG. 5, in the clockwise or counter clockwise direction to force the lever to the 100% cold rotation when in the off position. With careful selection of the spring 4, the water pressure force on the valves and stem or device 8, can increase the resistance of the rotation to counteract the torque spring 4 thereby allowing the user to select a hot position of some percentage mix without the lever or end 2g rotating back to cold when the lever or end 2g is on and released by the user. Other torque spring integration methods as this could also achieve the same results.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a handle device;
a valve device for controlling water flow, the valve device having a first opening; and
a device for biasing the handle device such that changing the handle device from an off state to an on state, without intentionally moving the handle device towards a hot water position or a cold water position, causes the handle device to cause the valve device to direct either hot or cold water, but not both, from either a hot supply pipe or a cold supply pipe, respectively, and out of an opening from the valve device.

2. The apparatus of claim 1
wherein the device for biasing the handle device includes a spring.

3. The apparatus of claim 1
wherein the handle device is configured with respect to the valve device, such that the handle device can rotate in a first plane, clockwise and counterclockwise, wherein rotating the handle device as far as it will go clockwise in the first plane, puts the handle device in a hot or cold water position, and rotating the handle device as far as it will go counterclockwise in the first plane, puts the handle device in a cold or hot water position, opposite that of the clockwise rotation;
wherein the handle device is configured with respect to the valve device, such that the handle device can rotate in a second plane, substantially perpendicular to the first plane, clockwise and counterclockwise, wherein rotating the handle device as far as it will go clockwise in the second plane, puts the handle device in an off or on state, and rotating the handle device as far as it will go counterclockwise in the second plane, puts the handle device in an on or off state, opposite that of the clockwise rotation;
wherein when the handle device is in a cold water position, and an on state, the handle device causes the valve device to direct cold water from a cold supply pipe out of the opening from the valve device; and
wherein when the handle device is in a hot water position, and an on state, the handle device causes the valve device to direct hot water from a hot supply pipe out of the opening from the valve device.

4. The apparatus of claim 1 wherein
the handle device is a single lever handle device.

5. The apparatus of claim 1 further comprising
a spout device, having a first opening and a second opening opposite the first opening; and
wherein the valve device directs water out of its opening into the first opening of the spout device, and then the water is directed by the spout device through the second opening of the spout device.

6. The apparatus of claim 2 wherein
the spring has a first end which is connected to the handle device and a second end opposite the first end of the spring, wherein the second end of the spring is fixed to a member which remains stationary while the handle device rotates, such that the spring is configured to apply torque on the handle device, when the handle device is rotated.

7. A method comprising the steps of:
using a device to bias a handle device of a faucet, such that changing the handle device from an off state to an on state, without intentionally moving the handle device towards a hot water position or a cold water position, causes the handle device to cause a valve device to direct either hot or cold water, but not both, from either a hot supply pipe or a cold supply pipe, respectively, and out of an opening from the valve device.

8. The method of claim 7 wherein
wherein the device for biasing the handle device includes a spring.

9. The method of claim 7
wherein the handle device is configured with respect to the valve device, such that the handle device can rotate in a first plane, clockwise and counterclockwise, wherein rotating the handle device as far as it will go clockwise in the first plane, puts the handle device in a hot or cold water position, and rotating the handle device as far as it will go counterclockwise in the first plane, puts the handle device in a cold or hot water position, opposite that of the clockwise rotation;
wherein the handle device is configured with respect to the valve device, such that the handle device can rotate in a second plane, substantially perpendicular to the first plane, clockwise and counterclockwise, wherein rotating the handle device as far as it will go clockwise in the second plane, puts the handle device in an off or on state, and rotating the handle device as far as it will go counterclockwise in the second plane, puts the handle device in an on or off state, opposite that of the clockwise rotation;
wherein when the handle device is in a cold water position, and an on state, the handle device causes the valve device to direct cold water from a cold supply pipe out of the opening from the valve device; and
wherein when the handle device is in a hot water position, and an on state, the handle device causes the valve device to direct hot water from a hot supply pipe out of the opening from the valve device.

10. The method of claim 7 wherein
the handle device is a single lever handle device.

11. The method of claim 7 wherein
wherein the valve device directs water out of its opening into the first opening of the spout device, and then the water is directed by the spout device through the second opening of the spout device.

12. The method of claim 8 wherein
the spring has a first end which is connected to the handle device and a second end opposite the first end of the spring, wherein the second end of the spring is fixed to a member which remains stationary while the handle device rotates, such that the spring is configured to apply torque on the handle device, when the handle device is rotated.
